(19) United States
(12) Patent Application Publication
(10) Pub. No.: US 2007/0126874 A1
(43) Pub. Date: Jun. 7, 2007

(54) Image processing device, image processing method, and information storage medium

(76) Inventor: Tomokazu Kake, Tokyo (JP)

Correspondence Address: KATTEN MUCHIN ROSENMAN LLP, 575 MADISON AVENUE, NEW YORK, NY, 10022-2585, US

(21) Appl. No.: 11/600,017

(22) Filed: Nov. 15, 2006

(30) Foreign Application Priority Data
Dec. 1, 2005 (JP) 2005-347602

(51) Int. Cl. H04N 7/18

(52) U.S. Cl. 348/159

(57) ABSTRACT

To control display on a screen using motion images of a plurality of users. The image processing device comprises an image acquiring section for acquiring images every predetermined period of time, each image being captured using each of the two or more cameras, an image displaying section for sequentially displaying on a screen the images acquired by the image acquiring section every predetermined period of time, and a display content control section for controlling content of a screen image shown on the screen, based on a relationship between the respective images captured using the two cameras and acquired by the image acquiring section.

### BACKGROUND OF THE INVENTION

1. Field of the Invention

The present invention relates to an image processing device, an image processing method, and an information storage medium, and in particular to an image processing device, an image processing method, and an information storage medium, all for displaying a screen image in which a user's motion image is shown.

2. Description of the Related Art

Japanese Patent No. 3298870 discloses an image processing device in which an image created by a computer and a motion image of a user are combined with each other, and displaying of a screen image is controlled based on the content of the motion image of the user. With this image processing device, the user can be presented as if the user were a dramatic personae appearing in the image created by the computer. This can double the attractiveness of game software or the like.

However, the above-described background technique is only capable of combining a motion image of a single user which is captured using a single camera and an image created using a computer, such that the motion image is shown in a fixed position in the computer-created image, and is not adapted to control of displaying of a screen image which is created using images which are captured using two or more cameras. Therefore, the above-described background technique has a difficulty in application to a game or communication carried out among two or more users.

The present invention has been conceived in view of the above, and aims to provide an image processing device, an image processing method, and an information storage medium, all capable of controlling displaying of a screen image which is created using images which are captured using two or more cameras.

### SUMMARY OF THE INVENTION

In order to solve the above described problems, according to one aspect of the present invention, there is provided an image processing device, comprising image acquiring means for acquiring images every predetermined period of time, each image being captured using each of the two or more cameras, image displaying means for sequentially displaying on a screen the images acquired by the image acquiring means every predetermined period of time, and display content control means for controlling content of a screen image shown on the screen, based on a relationship between the respective images captured using the two cameras and acquired by the image acquiring means.

Further, according to another aspect of the present invention, there is provided an image processing method, comprising an image acquiring step of acquiring images every predetermined period of time, each image being captured using each of the two or more cameras, an image displaying step of sequentially displaying on a screen the images acquired at the image acquiring step every predetermined period of time, and a display content control step of controlling content of a screen image shown on the screen, based on a relationship between the respective images captured using the two cameras and acquired at the image acquiring step.

Still further, according to yet another aspect of the present invention, there is provided an information storage medium storing a program for causing a computer to operate as image acquiring means for acquiring images every predetermined period of time, each image being captured using each of the two or more cameras; image displaying means for sequentially displaying on a screen the images acquired by the image acquiring means every predetermined period of time; and display content control means for controlling content of a screen image shown on the screen, based on a relationship between the respective images captured using the two cameras and acquired by the image acquiring means.

In the above, the computer may be, for example, a consumer game machine, a portable game device, a commercial game device, a personal computer, a server computer, a portable phone, a portable information terminal, and so forth. The program may be stored in a computer readable information storage medium, such as a DVD-ROM, a CD-ROM, a ROM cartridge, and so forth.

According to the present invention, the respective images captured using two or more cameras may be acquired every predetermined period of time and displayed on a screen. The content of the display is controlled based on the relationship between the images captured using two of these cameras. As a result, it is possible to change the content of the screen image according to the content of the images captured using the respective cameras. The present invention can be preferably applied to a game and/or communication carried out among a plurality of users.

It should be noted that the display content control means may be arranged so as to control the content of the screen image shown on the screen, based on the relationship between the contents of the respective images captured using the two cameras and acquired by the image acquiring means or the relationship between the motions of the objects shown in the images.

This arrangement makes it possible to desirably change the content of the screen image by users striking the same or similar poses or a making predetermined motion in front of the respective cameras, by adjusting the timing at which the users strike such poses or make such motion, or by capturing images of a specific object using the respective cameras.

In this case, the display content control means may create an image representative of a difference between the contents of the respective images captured using the two cameras, and control the content of the screen image shown on the screen based on the created image. The image representative of the difference may represent a difference between the contents of the images captured using the two cameras, acquired by the image acquiring means at different points in time, and displayed on the screen. Alternatively, the image representative of the difference may represent a difference between the contents of the images captured using the two cameras, acquired by the image acquiring means at the same point in time, and displayed on the screen.

Further, the display content control means may be arranged so as to control the content of the screen image shown on the screen based on whether or not the directions of the motions of the objects shown in the respective images captured using the two cameras and acquired by the image acquiring means hold predetermined relationship. This makes it possible to change the content of the screen image by objects making motions in a specific direction in front of the respective cameras.

### BRIEF DESCRIPTION OF THE DRAWINGS

FIG. 1 is a diagram showing a structure of a network system using an entertainment system (an image processing device) according to an embodiment of the present invention;

FIG. 2 is a diagram showing a hardware structure of the entertainment system according to the embodiment of the present invention;

FIG. 3 is a diagram showing an internal structure of an MPU;

FIG. 4 is a diagram showing one example of a screen image displayed (before application of effect) on a monitor in the entertainment system according to the embodiment of the present invention;

FIG. 5 is a diagram showing a screen image displayed (after application of effect) on the monitor in the entertainment system according to the embodiment of the present invention;

FIG. 6 is a block diagram showing functions of the entertainment system according to the embodiment of the present invention;

FIG. 7 is a diagram schematically showing the content stored in an image buffer;

FIG. 8 is a flowchart of an operation of the entertainment system according to the embodiment of the present invention;

FIGS. 9A and 9B are diagrams explaining another exemplary operation of the entertainment system according to the embodiment of the present invention;

FIGS. 10A and 10B are diagrams explaining still another exemplary operation of the entertainment system according to the embodiment of the present invention;

FIGS. 11A and 11B are diagram explaining yet another exemplary operation of the entertainment system according to the embodiment of the present invention;

FIGS. 12A to 12C are diagrams showing a process to create motion data of a user based on captured images in the entertainment system according to the embodiment of the present invention;

FIGS. 13A and 13B are diagrams showing a process to create motion data of a user based on captured images in the entertainment system according to the embodiment of the present invention; and

FIGS. 14A and 14B are diagrams explaining yet another exemplary operation of the entertainment system according to the embodiment of the present invention.

### DESCRIPTION OF THE PREFERRED EMBODIMENTS

In the following, an embodiment of the present invention will be described in detail with reference to the accompanying drawings.

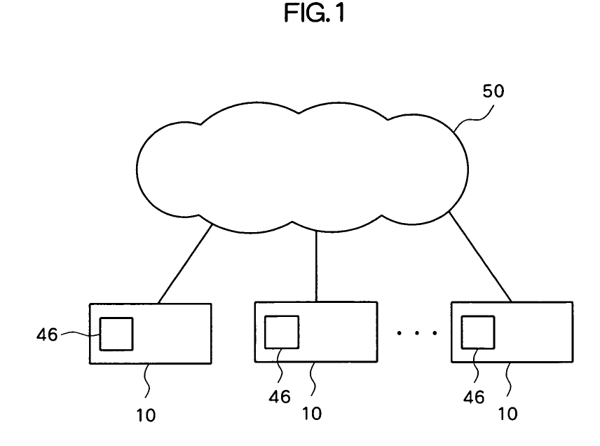

FIG. 1 is a diagram showing a structure of a network system which is constructed using an entertainment system (an image processing device) according to this embodiment. As shown in FIG. 1, the system comprises a plurality of entertainment systems 10 connected to a network 50, such as the Internet, a LAN, or the like. Each of the entertainment systems 10 is constructed having a computer to which a camera unit 46 for capturing a motion image of a user is connected. Through exchange of data on a motion image of a user via the network 50, it is possible to display common screen images in which motion images of a plurality of users are shown, in the respective entertainment systems 10.

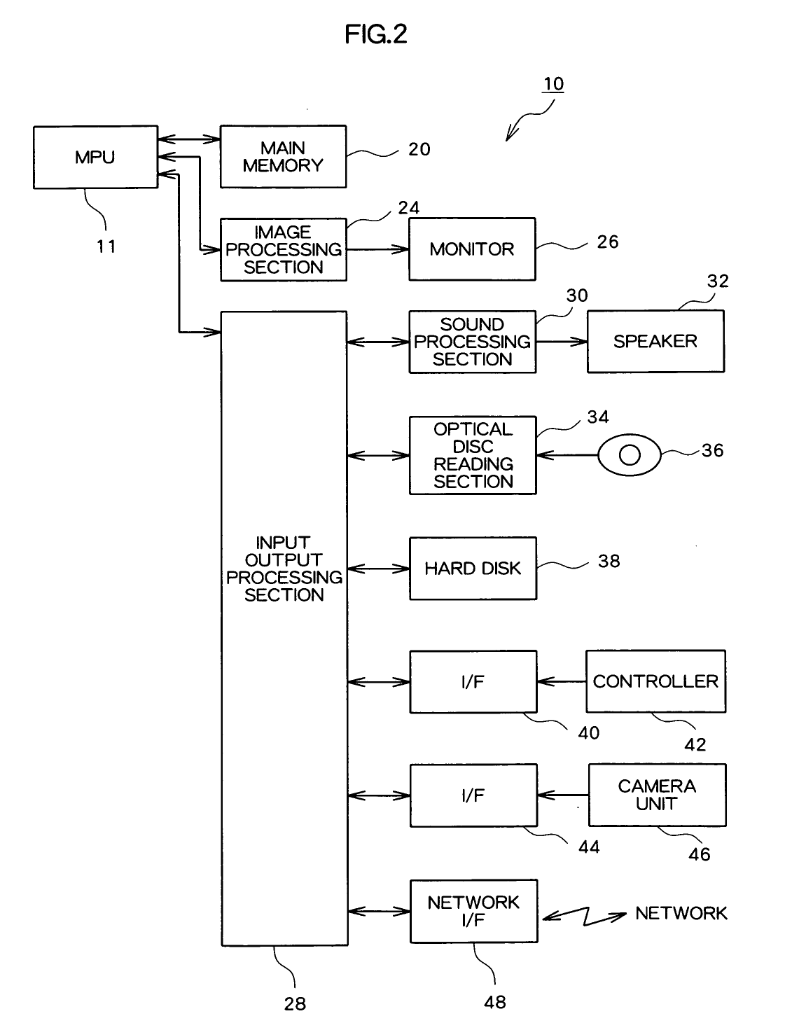

FIG. 2 is a diagram showing a hardware structure of the entertainment system (an image processing device) according to this embodiment. As shown in FIG. 2, the entertainment system 10 is a computer system which is constructed comprising an MPU (a Micro Processing Unit) 11, a main memory 20, an image processing section 24, a monitor 26, an input output processing section 28, a sound processing section 30, a speaker 32, an optical disc reading section 34, an optical disc 36, a hard disk 38, interfaces (I/F) 40, 44, a controller 42, a camera unit 46, and a network interface 48.

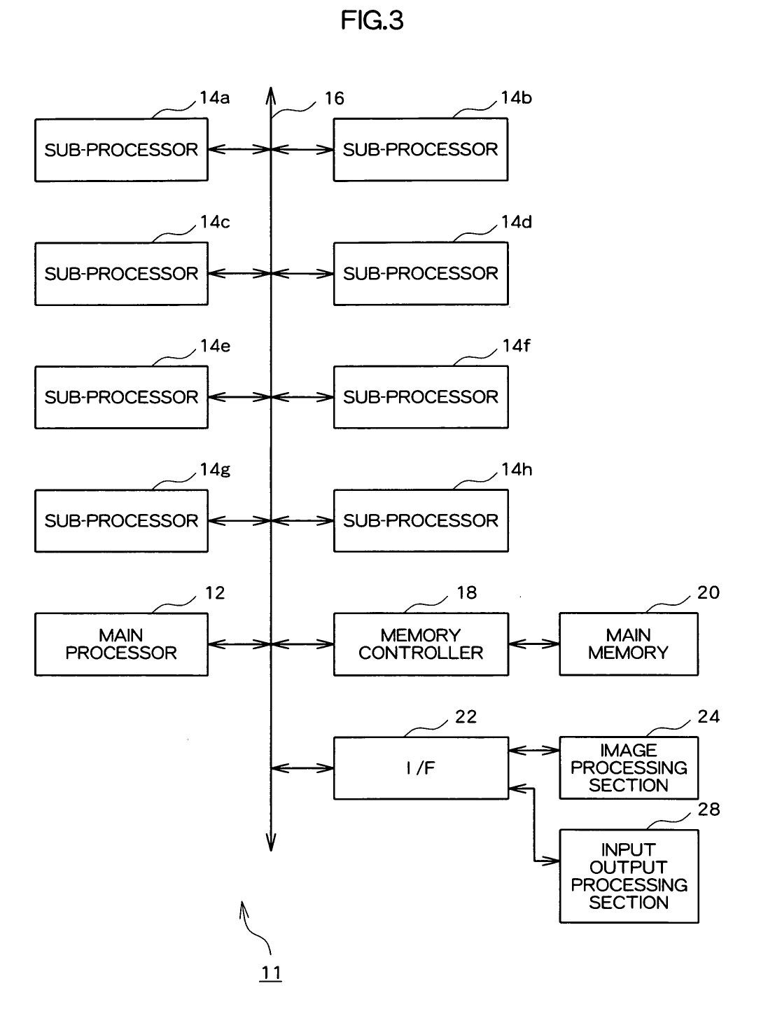

FIG. 3 is a diagram showing a structure of the MPU 11. As shown in FIG. 3, the MPU 11 is constructed comprising a main processor 12, sub-processors 14a through 14h, a bus 16, a memory controller 18, and an interface (I/F) 22.

The main processor 12 carries out a variety of information processing and control relating to the sub-processors 14a through 14h based on a program and data which are read from an operating system, including an optical disc 36, such as a DVD (a Digital Versatile Disk)-ROM or the like, stored in a ROM (a Read Only Memory) (not shown) or supplied via a communication network.

The sub-processors 14a through 14h each carry out a variety of information processing while following an instruction supplied from the main processor 12, and control the respective sections of the entertainment system 10 based on, for example, a program, data, and so forth, read from the optical disc 36 such as a DVD-ROM or the like or provided via the network 50.

The bus 16 is employed to enable exchange of an address and data among the respective sections of the entertainment system 10. The main processor 12, the sub-processors 14a through 14h, the memory controller 18, and the interface 22 are connected to one another so as to enable data exchange via the bus 16.

According to an instruction supplied from the main processor 12 and the sub-processors 14a through 14h, the memory controller 18 makes an access to the main memory 20.

Here, a program and data read from the optical disc 36 or the hard disk 38 or supplied via a communication network are written into the main memory 20 as required. The main memory 20 may also be used as a work memory for the main processor 12 and the sub-processors 14a through 14h.

The interface 22 is connected to the image processing section 24 and the input output processing section 28. Data exchange between the main processor 12 and the sub-processors 14a through 14h and the image processing section 24 or the input output processing section 28 is carried out via the interface 22.

The image processing section 24 is constructed comprising a GPU (a Graphical Processing Unit) and a frame buffer. The GPU draws a variety of screen images in the frame buffer based on the image data supplied from the main processor 12 and/or the sub-processors 14a through 14h. A screen image drawn in the frame buffer is converted into a video signal at predetermined timing before being output to the monitor 26. Here, it should be noted that a home-use television set receiver, for example, may be used to serve as the monitor 26.

The input output processing section 28 is connected to the sound processing section 30, the optical disc reading section 34, the hard disk 38, and interfaces 40, 44. The input output processing section 28 controls data exchange between the main processor 12 and the sub-processors 14a through 14h and the sound processing section 30, the optical disc reading section 34, the hard disk 38, the interfaces 40, 44, and the network interface 48.

The sound processing section 30 is constructed comprising an SPU (a Sound Processing Unit) and a sound buffer. In the sound buffer, a variety of sound data including game music, game sound effect, a message, and so forth, which are read from the optical disc 40 or the hard disk 38 is held. The SPU reproduces the variety of sound data and outputs via the speaker 32. It should be noted that a built-in speaker of a home-use television set receiver, for example, may be used to serve as the speaker 32.

According to an instruction supplied from the main processor 12 and the sub-processors 14a through 14h, the optical disc reading section 34 reads a program and data recorded in the optical disc 36. It should be noted that the entertainment system 10 may be constructed capable of reading a program and data stored in any information storage medium other than the optical disc 36.

The optical disc 36 may be, for example, a typical optical disc (a computer readable information storage medium), such as a DVD-ROM, or the like. Also, the hard disk 38 is a typical hard disk device. In the optical disc 36 and/or the hard disk 38, a variety of programs and data are stored in computer-readable form.

The interfaces (I/F) 40, 44 each serve as an interface for connecting a variety of peripheral devices such as the controller 42, the camera unit 46, or the like, to one another. As such an interface, a USB (a Universal Serial Bus), for example, may be used.

The controller 42 is a general purpose operation input means, and used by a user to input a variety of operations (for example, a game operation). The input output processing section 28 scans the respective portions of the controller 42 every predetermined period of time (for example, 1/60 second) to obtain information on the states of the portions, and an operational signal indicative of the result of the scanning is supplied to the main processor 12 and/or the sub-processors 14a through 14h. The main processor 12 and the sub-processors 14a through 14h determine the content of the user's operation based on the operational signal.

It should be noted that the entertainment system 10 is constructed capable of connecting a plurality of controllers 42 to one another, so that the main processor 12 and the sub-processors 14a through 14h carry out a variety of processing based on an operational signal input from each of the controllers 42.

The camera unit 46 is constructed comprising a known digital camera, for example, and inputs a black and white (B/W) or color captured image every predetermined period of time (for example, 1/60 second). The camera unit 46 in this embodiment is designed to input a captured image as image data prepared in the form of JPEG (Joint Photographic Experts Group). Also, the camera unit 46 is mounted to the monitor 26 such that, for example, the lens thereof faces the player, and is connected via a cable to the interface 44. The network interface 48 is connected to the input output processing section 28 and the network 50, and relays data communication carried out by the entertainment system 10 to other entertainment systems 10 via the network 50.

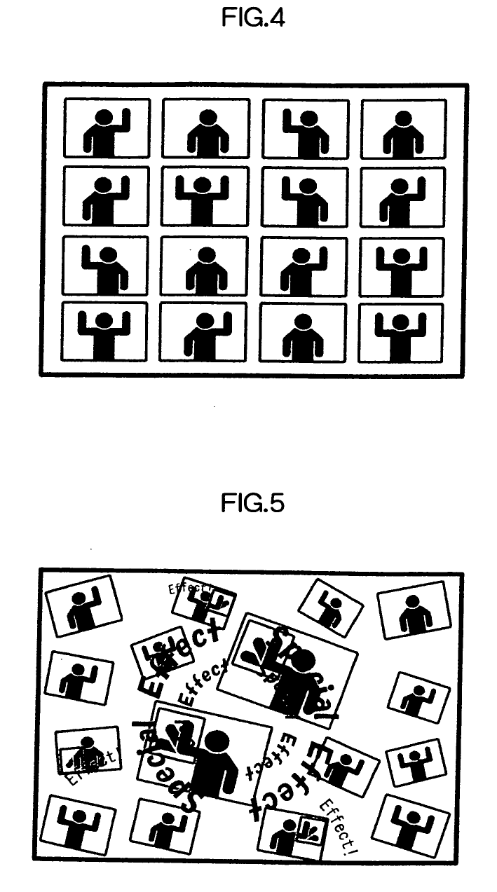

FIG. 4 is a diagram showing a screen image to be shown on the monitor 26 in one entertainment system 10 according to this embodiment. As shown in FIG. 4, the screen image displayed on the monitor 26 contains the image (a motion image) of a user which is captured using the camera unit 46 connected to the entertainment system 10 to which the monitor 26 is also connected, and obtained every predetermined period of time, and the images (motion images) of other users which are captured using other entertainment systems 10 via the network and sent therefrom every predetermined period of time (16 motion images in total in FIG. 4). The images of the respective users are arranged in horizontal and vertical directions, so that which user is striking what pose shown in the respective images can be known at a glance.

In this embodiment, whether or not there are any images in the plurality of images, which make a pair in the sense that the images hold a predetermined relationship to each other, is determined. Thereafter, based on the result of the determination, effect is applied to the screen image to be shown on the monitor 26. Specifically, in the entertainment system 10, whether or not there are any images, among the images captured using its own camera 46 or the other cameras 46, in which users in the same or similar poses are shown is determined, and when there are any, effect is applied to the screen image.

FIG. 5 is a diagram showing one example of a screen image with effect applied thereto. As shown in FIG. 5, with effect applied, the images of the respective users are moved to be positioned differently from the screen image without effect applied thereto (see FIG. 4). Also, an image or character for effect is additionally displayed. FIG. 5 shows an example of a screen image with effect applied thereto in the sense that two images shown in a relatively large size and located near the center of the screen show users in the same or similar poses or motions.

In the case where the two images do not completely match, the images may be positioned relative to the center of the screen image as determined depending on the degree of similarity between the images. Specifically, with respect to the image of a user with one hand raised, an image which completely coincides with that image may be positioned at the center of the screen image, while the image of a user with both of their hands raised may be positioned slightly away from the center of the screen image. Further, the image of a user with both of their hands down may be positioned further away from the center of the screen image.

That is, the similarity between the images is converted into a distance in a two or three-dimensional space, so that the positional pattern is controlled accordingly. With an arrangement in which the similarity between the images is converted into a distance and shown in a (two or three-dimensional) space, the degree of difference between the images can be visually confirmed.

Further, with an arrangement in which not only the distance but also a position where each image is placed (a direction relative to the center of the screen image or the like) is given with some meaning, similarity between the images can be more readily recognized. For example, with respect to a pose in which both hands are raised, the image of a pose with only a left hand raised may be positioned on the left side of the screen image relative to the center of the screen image, while the image of a pose with only a right hand raised may be positioned on the right side relative to the center of the screen image.

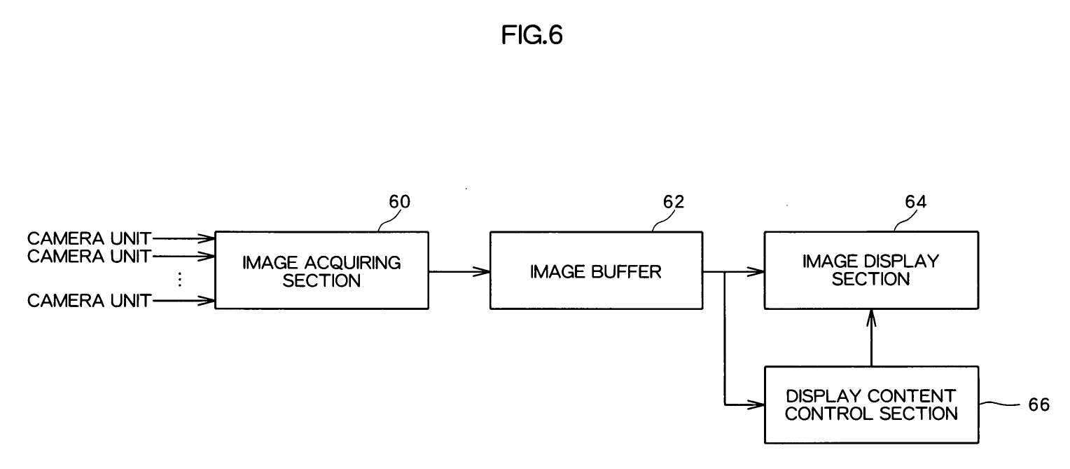

FIG. 6 is a functional diagram for the entertainment system 10. As shown in FIG. 6, the entertainment system 10 comprises, in terms of function, an image acquiring section 60, an image buffer 62, an image display section 64, and a display content control section 66. These functions are realized by the entertainment system 10 by executing a program stored in the optical disc 36.

Specifically, the image acquiring section 60 obtains an image captured every predetermined period of time, using the camera unit 46 of the entertainment system 10 in which the image acquiring section 60 is realized, and stores sequentially in the image buffer 62. The image acquiring section 60 additionally acquires, every predetermined period of time, images which are captured using camera units 46 of other entertainment systems 10 every predetermined period of time and sent to the object entertainment system 10 to which the image acquiring section 60 is realized (that is, images showing users of the other entertainment systems 10), and additionally sequentially stores the images in the image buffer 62.

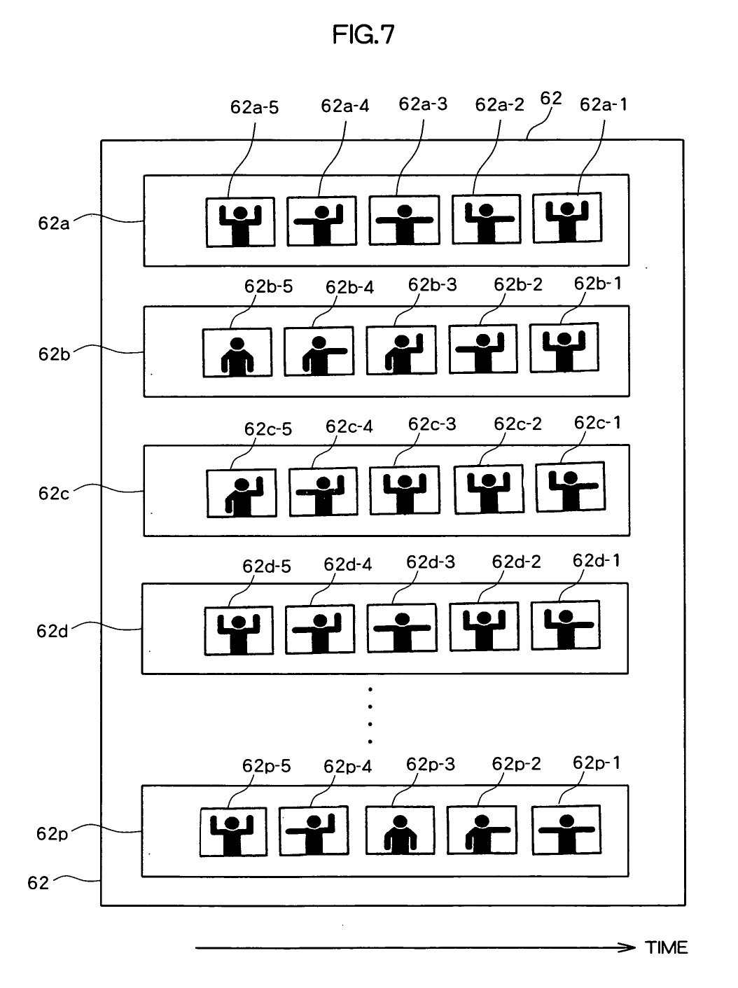

The image buffer 62 is constructed having the main memory 20, for example, as a main component, and including a plurality of (sixteen, here) individual image buffers 62a through 62p corresponding to the camera units 46 of the respective entertainment systems 10, as shown in FIG. 7. Each of the individual image buffers 62x stores five images 62x-1 through 62x-5 in total which are captured using the relevant camera unit 46 in which the image 62x-1 is captured earliest, thus being the oldest image and the image 62x-5 is captured last, being the newest image. Every time a new image is captured, the oldest image, namely, the image 62x-1, is discarded, and the newly captured image is stored instead in the individual image buffer 62x (x=a through p). In this manner, five latest captured images of a user are sequentially stored in each of the individual image buffers 62a through 62p.

The image display section 64 reads the earliest captured images 62 from the respective individual image buffers 62a through 62p to create a screen image by arranging the images, and displays the created screen image on the monitor 62.

In the above, the display content control section 66 compares the contents of the earliest captured images 62 collected from the respective image buffers 62a through 62p to see whether or not there are any images of users in similar poses. Should such images be found, an instruction is sent to the image display section 62 to request application of effect.

Upon receipt of the instruction, the image display section 64 applies various effects to change the positions of the respective images in the screen image and to add an effect image including a character, a pattern, and so forth to the screen image, and so forth.

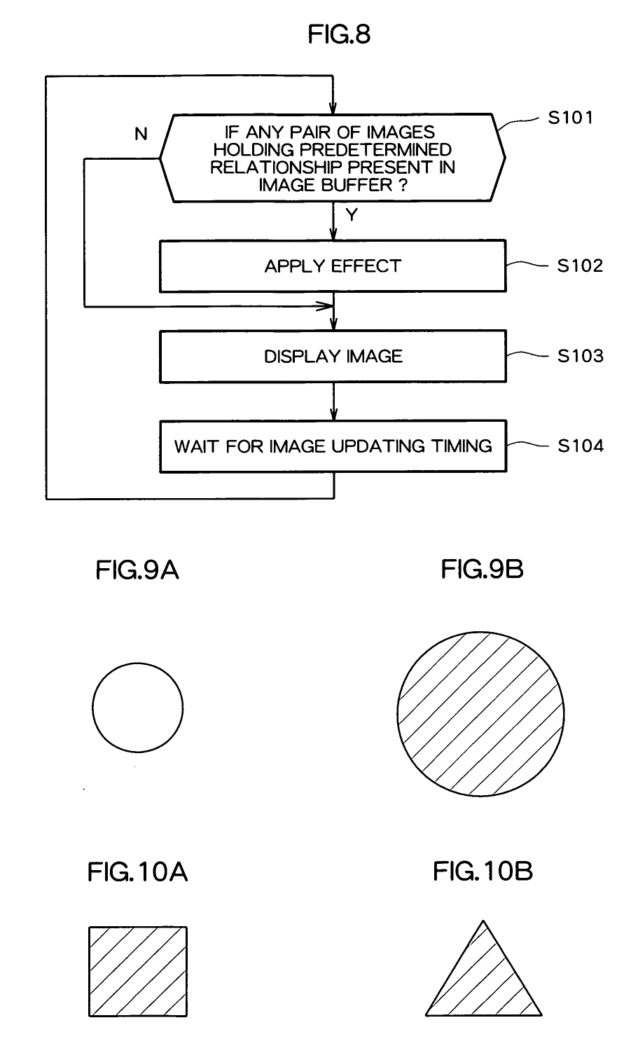

FIG. 8 is a flowchart of imaging processing to be carried out by the entertainment system 10. As shown in FIG. 8, in the entertainment system 10, the display content control section 66 obtains the oldest images 62a-1 through 62p-1 from the respective individual image buffers 62a through 62p, and determines whether or not there are any images of users in the same or similar poses (S101).

Specifically, after the images 62a-1 through 62p-1 are obtained, the background portion is eliminated from each of the images 62a-1 through 62p-1, and the resultant image is binarized to thereby create a binary image. In this manner, a binary image in which the value “1” is associated with the pixels in the area where the image of the user (an object) is shown and the value “0” is associated with the pixels in other areas (the background area) can be obtained.

Thereafter, a differential image of the binary images of the images 62a-1 through 62p-1 is created. A differential image is an image indicative of a difference in the contents of the images 62a-1 through 62p-1 which are captured using the respective camera units 46. When the difference is equal to or smaller than a predetermined amount, it is determined that the two images (or an image pair) relevant to that difference are those of users in the same or similar poses.

As described above, it is determined whether or not there are any images among the images 62a-1 through 62p-1 which make a pair in the sense that the images relate to users in the same or similar poses. When such a pair is present, the display content control section 66 instructs the image display section 64 to apply effect (S102). On the other hand, when no such a pair is present, the display content control section 66 does not instruct the image display section 64 to apply effect.

The image display section 64 reads the images 62a-1 through 62p-1 from the image buffers 62, creates a screen image based on the images while applying effect according to the instruction sent from the display content control section 66, and displays the resultant image on the monitor 26 (S103). Thereafter, then next timing for update of the screen image is awaited (S104) before the processing at 101 and thereafter is repeated.

As described above, the processing at S101 through S104 is repeatedly carried out every predetermined period of time, whereby a motion image is displayed on the monitor 26.

According to the imaging processing as described above, when users strike the same or similar poses at the same timing in front of the relevant camera units 46 of the respective entertainment systems 10, effect is accordingly caused to be applied to a screen image displayed on the respective monitors 26. This can realize an attractive system.

It should be noted that, although it is described in the above that the display content control section 66 determines whether or not there are any images, among the images 62a-1 through 62p-1 captured at the same timing, which relate to users in the same or similar poses, an arrangement is also applicable in which it is determined whether or not there are any images of users in the same or similar poses among the images captured at different timing.

Specifically, the image 62x-1 which is captured using one of the camera units 46 is compared with the images 62y-n (y being all except x; n being a predetermined value larger than one (for example, two)) which are captured using other camera units 46 at timing later by a predetermined period of time than the timing at which the image 62x-1 is captured, to determine whether or not each of the images 62y-n shows the user in the same or similar poses as that of the user shown in the image 62x-1 (x, y=a through p). This arrangement makes it possible to initiate application of effect to a screen image in response to a user who imitates another user striking a pose while looking at the screen image.

It should be noted here that although the display content control section 66 determines whether or not there are any images, among the images 62a-1 through 62p-1, which relate to users in the same or similar poses so that effect is applied to a screen image depending on the result of the determination, an arrangement is also applicable in which it may be determined whether or not images of objects (an object for imaging) of the same shape are captured using two or more camera units 46, as shown in FIGS. 9A and 9B. Alternatively, whether or not images of the objects (an object for imaging) of the same color are captured using two or more camera units 46 may be determined, as shown in FIG. 10A and 10B.

Still alternatively, the display content control section 66 may determine whether or not there are any images showing the same kinds of motion and captured using different camera units 46, so that effect is applied to the screen image depending on the result of the determination.

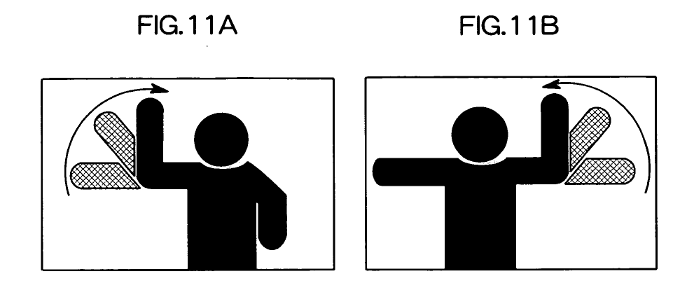

That is, when a user flips their right hand upward from its horizontally extending position, as shown in FIG. 11A, and the image of a user making the same motion is captured using another camera 46, effect may be applied to the screen image. On other hand, when only the images of users doing different motions, as shown in FIG. 11B, are captured using the other cameras 46, no effect may be applied to the screen image.

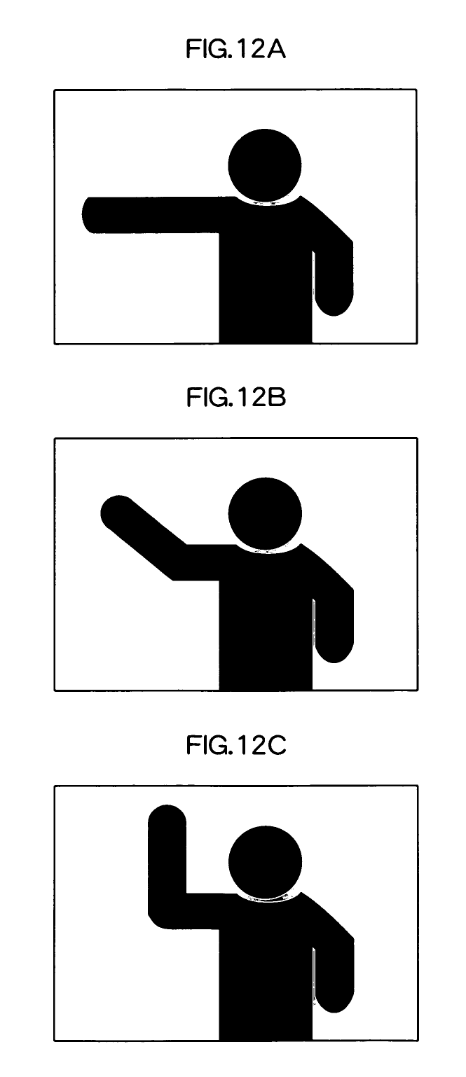

For example, as shown in FIGS. 12A through 12C, when a user flips their right hand upward from its horizontally extending position and the images of the user making such a motion are sequentially captured using the camera unit 46, a differential image with respect to the last captured image is created every time an image is newly captured using the camera unit 46, and a representative position, such as the position of the center of gravity of the differential region shown in the differential image, is calculated.

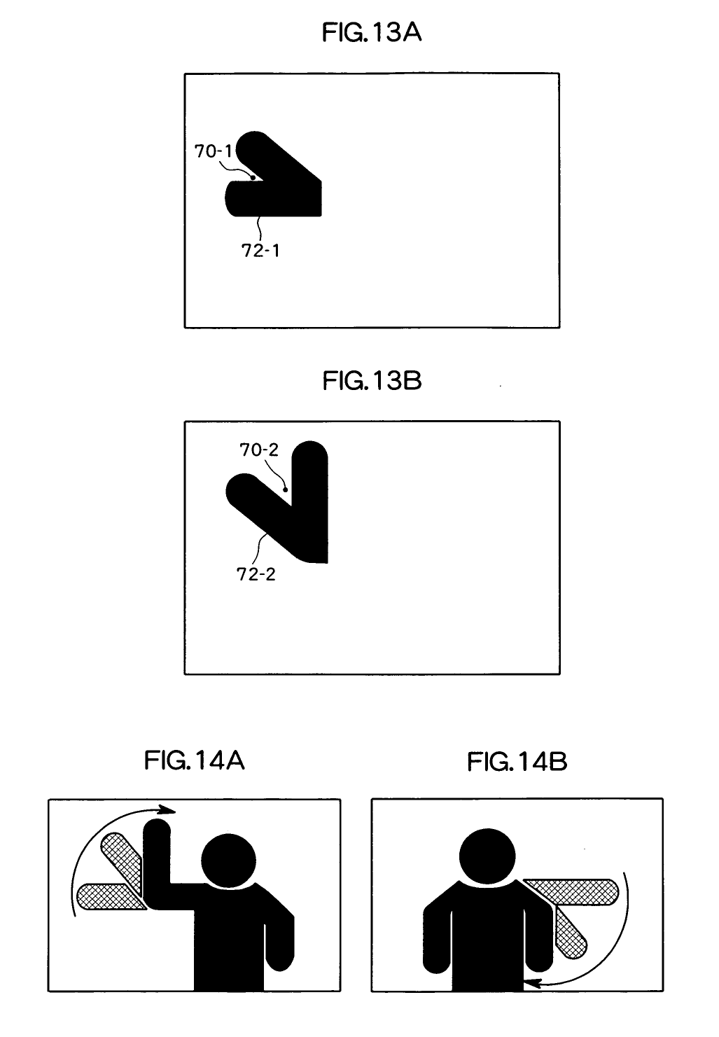

FIG. 13A shows a differential image concerning the image of FIG. 12B and the image of FIG. 12A, which is captured immediately before the image of FIG. 12B, in which a differential region 72-1 is shown. With respect to this differential region 72-1, a representative position 70-1 is calculated.

FIG. 13B shows a differential image concerning the image of FIG. 12C and the image of FIG. 12B, which is captured immediately before the image of FIG. 12C, in which a differential region 72-2 is shown. With respect to this differential region 72-2, a representative position 70-2 is calculated.

Then, the data of a vector connecting the representative positions 70 calculated at the respective points in time is defined as motion data representing the motion of the user subjected to image capturing by the camera unit 46.

The above described motion data is prepared for the respective captured images relative to all camera units 46, and compared with one another. This makes it possible to determine whether or not the users subjected to image capturing by the respective camera units 46 perform the same or similar motions.

With this arrangement, it is possible to achieve applications of a massive multiplayer network game (for example, a fighting game, a role playing game, a dancing game, and so forth, in which images of players making a gesture are captured using the camera units and the captured images are analyzed before a command is input), or the like, such that, for example, when a plurality of players strike the same attacking pose, and so forth, multiple-powered damage can be caused to an opponent character. This makes it possible to realize a variety of fascinating game applications.

In the above, with an arrangement in which the motion data are directly compared to each other, there may be a case in which users making motions in the same direction, as shown in FIGS. 14 A and 14B, may be determined as making different motions.

In view of the above, the direction of motion (for example, the rotation direction with the center defined at the center of the screen) is calculated based on the above-described motion data, and the calculated directions are then compared. This makes it possible to determine whether or not the users subjected to image capturing by the respective camera units 46 perform motion in the same or similar directions. With an arrangement in which effect is applied to the screen image based on the result of the determination, a user can initiate application of effect to a screen image by setting up a motion in the same direction as that of the motion of another user.

What is claimed is:

1. An image processing device, comprising:
image acquiring means for acquiring images every predetermined period of time, each image being captured using each of two or more cameras;
image displaying means for sequentially displaying on a screen the images acquired by the image acquiring means every predetermined period of time; and
display content control means for controlling content of a screen image shown on the screen, based on a relationship between the respective images captured using the two cameras and acquired by the image acquiring means.

2. The image processing device according to claim 1,
wherein
the display content control means controls the content of the screen image shown on the screen, based on the relationship between contents of the respective images captured using the two cameras and acquired by the image acquiring means or relationship between motions of objects shown in the images.

3. The image processing device according to claim 2,
wherein
the display content control means creates an image representative of a difference between the contents of the respective images captured using the two cameras, and controls the content of the screen image shown on the screen based on the image.

4. The image processing device according to claim 3,
wherein
the display content control means creates the image representative of the difference between the contents of the images captured using the two cameras, acquired by the image acquiring means at different points in time, and displayed on the screen, and controls the content of the screen image shown on the screen based on the image.

5. The image processing device according to claim 3,
wherein
the display content control means creates the image representative of the difference between the contents of the images captured using the two cameras, acquired by the image acquiring means at the same point in time, and displayed on the screen, and controls the content of the screen image shown on the screen based on the image.

6. The image processing device according to claim 2,
wherein
the display content control means controls the content of the screen image shown on the screen based on whether or not directions of motions of objects shown in the respective images captured using the two cameras and acquired by the image acquiring means, hold a predetermined relationship.

7. An image processing method, comprising:
an image acquiring step of acquiring images every predetermined period of time, each image being captured using each of the two or more cameras;
an image displaying step of sequentially displaying on a screen the images acquired at the image acquiring step every predetermined period of time; and
a display content control step of controlling content of a screen image shown on the screen, based on a relationship between the respective images captured using the two cameras and acquired at the image acquiring step.

8. An information storage medium storing a program for causing a computer to operate as
image acquiring means for acquiring images every predetermined period of time, each image being captured using each of the two or more cameras;
image displaying means for sequentially displaying on a screen the images acquired by the image acquiring means every predetermined period of time; and
display content control means for controlling content of a screen image shown on the screen, based on a relationship between the respective images captured using the two cameras and acquired by the image acquiring means.
